(19) United States
(12) Patent Application Publication
(10) Pub. No.: US 2024/0367415 A1
(43) Pub. Date: Nov. 7, 2024

(54) DECORATIVE ELEMENT

(71) Applicant: Hueck Folien Gesellschaft m.b.H., Baumgartenberg (AT)

(72) Inventors: Anita FUCHSBAUER, Linz (AT); Martin EGGINGER, Linz (AT); Stephan TRASSL, Baumgartenberg (AT); Olivier LORRET, Enndsorf (AT)

(21) Appl. No.: 18/687,494

(22) PCT Filed: Aug. 29, 2022
(86) PCT No.: PCT/AT2022/060296

§ 371 Date: Feb. 28, 2024

(30) Foreign Application Priority Data
Aug. 30, 2021 (EP) 21193860.0

(51) Int. Cl. B32B 7/12; B32B 15/08; B44C 5/04

(52) U.S. Cl. CPC B32B 7/12; B32B 15/08; B44C 5/04; B32B 2305/70; B32B 2307/7163

(57) ABSTRACT

A decorative element comprises a support layer and a cover layer arranged on the support layer. The decorative element comprises at least one recycled material, and/or at least one material made of renewable raw materials, and/or at least one biologically degradable and/or marine-degradable material. Component composites with at least one such decorative element arranged on a surface of the component composite are also disclosed.

### RELATED APPLICATIONS

This is a national stage under 35 U.S.C. § 371 of International Application No. PCT/AT2022/060296, filed Aug. 29, 2022, which claims priority of European Patent Application No. 21193860.0, filed Aug. 30, 2021.

### TECHNICAL FIELD

The field of this disclosure relates to a decorative element comprising a support layer and a cover layer arranged on the support layer and to a component composite comprising the decorative element and an object.

### BACKGROUND

A decorative film of the type mentioned above has become known to those skilled in the art through WO 2020/234301 A1, for example.

Film-like decorative elements are used, among other things, for the surface design of a wide variety of objects or components or supporting structures, in particular flat components. For example, metal or plastic surfaces, but also surfaces made of wood, wood composites, glass, ceramics, inorganic building materials such as concrete or eternit, or materials containing cellulose, may be provided with visually appealing designs using decorative elements. For this purpose, decorative elements are applied or arranged on surfaces or flat sides of objects, components or supporting structures. Film-like decorative elements must therefore, in addition to an attractive appearance, meet high requirements with regard to adhesion and also crease- and bubble-free application to a surface or flat side of an object or supporting structure.

In order to fulfill all these tasks, decorative elements usually consist of a number of interconnected layers or films made of different materials and therefore cannot usually be disposed of separately by an end user. This often results in contamination of the disposal fraction when disposing of items with decorative elements. For example, when disposing of packaging with plastic-containing decorative films, these same plastics end up in the paper waste in an undesirable way.

### SUMMARY

A need remains for decorative elements that overcome the remaining disadvantages of the prior art and to further improve the sustainability of decorative elements, while at the same time not impairing the required technical properties of the decorative elements.

It should be noted that the term “in particular” in this document is understood to mean a possible more specific embodiment or more detailed specification of an object, but does not necessarily have to represent a mandatory, preferred embodiment thereof or a mandatory approach.

As used herein, the terms “comprising”, “has”, “having”, “includes”, “including”, “contains”, “containing” and any variations thereof are intended to cover non-exclusive inclusion.

At this point, it should also be noted that the term “layer” in the context of the present disclosure may describe both a single layer and a composite or a layering of several layers. This may involve several layers of the same type, for example, but also several different types of layers. The same applies to the term “film”. It should also be noted that “coating” in this document is understood to mean both indirect and direct coating. In this sense, throughout the document, “a first layer is coated with a second layer” means both that the second layer is applied directly and immediately to the first layer without an intermediate layer and is in contact with it, and also that intermediate layers, for example in the form of adhesion promoters, etc., may be arranged between the first layer and the second layer.

The present disclosure relates to a decorative element in which it is provided that the decorative element comprises at least one recycled material, and/or at least one material made of renewable raw materials, and/or at least one biologically degradable and/or marine-degradable material.

In the present context, the term “decorative element” refers in particular to film-like decorative elements or adhesive films. Decorative elements usually comprise a support layer, or a support or base film, which serves as a support material for various optically effective layers, for example, but also for functional layers and for print layers. The support layer has two flat sides. In addition, decorative elements comprise a cover layer, which also has two flat sides. The cover layer and the support layer are therefore each configured as a flat layer and are connected to each other on their flat sides facing each other. Decorative elements are also often attached to a surface or flat side of an object or supporting structure by means of an adhesive layer, laminating layer or self-adhesive layer, either permanently or, if necessary, detachably.

The at least one recycled material may be any type of recyclable material or material composition. For example, this includes all types of plastics, as well as metals, metal alloys or metal compounds. Various chemical compositions may also be recyclable and thus be included in the decorative element as recycled material. Because decorative elements are usually made up of several layers, films or components, it may be useful if different types of recycled material are used in these individual components.

It is conceivable that the at least one recycled material and/or the at least one material made of renewable raw materials and/or the at least one biologically degradable and/or marine-degradable material is contained in the support layer, in the cover layer and/or in a further component, layer or film applied on or under the support layer. In the context of the following description, the phrase “under the support layer” means that any additional components, layers or films are arranged on the side of the support layer facing the surface of an object. The phrase “on the support layer” means that any additional components, layers or films are arranged on the side of the support layer facing away from the surface of an object or on the side of the decorative element facing the visible side.

This improves the sustainability of the decorative element and its entire product life cycle, as the use of at least one recycled material enables the sustainable production. By using at least one recycled material in the production of decorative elements, means are created which meet the increasing ecological requirements.

The sustainable life cycle of the decorative element may be further improved by the alternative or additional use of at least one material made of renewable raw materials and/or biologically degradable and/or marine-degradable material. It may also make a valuable contribution to environmental protection. The material made of renewable raw materials or the biologically degradable and/or marine-degradable material may be a material other than the recycled material. However, it is particularly sustainable if the material made of renewable raw materials or the biologically degradable and/or marine-degradable material is the same material as the recycled material.

Renewable raw materials may be used for the synthesis of the corresponding chemical raw materials. Plastics may, for example, be divided into so-called drop-ins and new bio-based plastics. Drop-ins are bioplastics that are based on renewable raw materials and for which existing processes and value chains remain essentially unchanged during processing, use and recycling (e.g. PA, PU, PE, PP, PET, etc.). New bio-based plastics are replacing fossil-based plastics (e.g. thermoplastic starch (TPS), polylactic acid (PLA), cellulose- or lignin-based plastics, etc.), although their use as an alternative to fossil-based plastics is not yet fully established for all bio-based plastics.

Biologically degradable plastics consist of polymers that can be decomposed by microorganisms under certain conditions. The term “marine-degradable” refers to the possibility of natural degradation under marine environmental conditions. Biologically degradable and bio-based plastics include polyhydroxyalkanoates (PHA) and thermoplastic starch (TPS), for example. Biologically degradable plastics include, for example, polylactic acid (PLA), polycaprolactone (PCL), polybutylene succinate (PBS) and polybutylene adipate terephthalate (PBAT).

By using sustainably produced raw films and/or raw materials, for example as coating materials, decorative elements can be produced sustainably without impairing the required technical properties such as appearance, adhesion to surfaces, printability of the base or cover layer, or a layer applied on or in the cover layer.

According to an advantageous further embodiment, a connection layer may be provided by means of which the cover layer is connected to the support layer. Preferably, the connection layer comprises at least one recycled material, and/or at least one material made of renewable raw materials, and/or at least one biologically degradable and/or marine-degradable material. This makes it possible to ensure a good and durable bond between the layers to be joined. A further preferred embodiment is characterized in that the connection layer is formed by a laminating agent, in particular by a laminating adhesive, a laminating varnish or a laminating glue. This creates a good and stable mutual connection.

Furthermore, it may be useful if the decorative element comprises at least 10%, preferably at least 20%, particularly preferably at least 30%, in particular at least 50% of the at least one recycled material and/or the at least one material made of renewable raw materials and/or the at least one biologically degradable and/or marine-degradable material, or if the decorative element comprises at least 10%, preferably at least 20%, particularly preferably at least 30%, in particular at least 50% of several recycled materials and/or several materials made of renewable raw materials and/or several biologically degradable and/or marine-degradable materials.

Furthermore, it may be provided that the at least one recycled material, and/or the at least one material made of renewable raw materials, and/or the at least one biologically degradable and/or marine-degradable material is a cellulose fiber free material.

In addition, it may be provided that the decorative element, in particular the support layer, is configured with at least one plastic film or as a plastic film, which plastic film comprises the at least one recycled material and/or the at least one material made of renewable raw materials and/or the at least one biologically degradable and/or marine-degradable material. The plastic film may, for example, be a polymer support film or a polymer substrate to which other layers such as decorative layers, protective varnishes, heat-sealing varnishes, adhesives, etc. may be applied.

An embodiment according to which it may be provided that the at least one recycled material and/or the at least one biologically degradable and/or marine-degradable material comprises a chemically recycled plastic and/or a mechanically recycled plastic, in particular comprises a translucent recycled plastic, is also advantageous, wherein the at least one recycled material and/or the at least one biologically degradable and/or marine-degradable material preferably comprises at least one of the materials from the group consisting of polyimide (PI), polypropylene (PP), monoaxially oriented polypropylene (MOPP) biaxially oriented polypropylene (BOPP), polyethylene (PE), polyphenylene sulphide (PPS), polyetheretherketone (PEEK), polyetherketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), glycol-modified polyethylene terephthalate (G-PET), amorphous polyethylene terephthalate (A-PET), polyamide (PA), polycarbonate (PC), cycloolefin copolymers (COC), polyoxymethylene (POM), acrylonitrile-butadiene-styrene (ABS), polyvinyl chloride (PVC), ethylene tetrafluoroethylene (ETFE), polytetrafluoroethylene (PTFE), polyvinyl fluoride (PVF), polyvinylidene fluoride (PVDF), ethylene-tetrafluoroethylene-hexafluoropropylene fluorterpolymer (EFEP), polymethyl methacrylate (PMMA), cellulose or lignin-based plastics, polyhydroxyalkanoates (PHA), thermoplastic starch (TPS), polylactic acid (PLA), polycaprolactone (PCL), polybutylene succinate (PBS), and polybutylene adipate terephthalate (PBAT) and/or mixtures and/or co-polymers and/or composites of these materials or is made from at least one of these materials. Preferably, the decorative element, in particular the support layer, as described above, may be configured with at least one plastic film or as a plastic film, for example as a polymeric support film as a polymer substrate, and this plastic film may comprise one or more of the listed materials.

Chemical recycling refers to methods in which plastics are broken down into shorter molecules by thermal or energy effects or by chemical processes so that they can be reused in subsequent manufacturing processes such as polymerization. So-called PCR plastics (“post consumer recycling”), PIR plastics (“post industrial recycling”) and CCU plastics (“carbon capture and utilization”), for example, may be chemically recycled.

For the production of PCR plastics, plastic waste is converted back into raw materials or monomers for the production of new raw materials after end use and used to produce polymer films or paint components, for example. For example, PET, PE and PP films may be sourced with a certain proportion of PCR raw materials. The production of PIR plastics is generally similar to the production of PCR plastics. However, industrial waste is used here, which is generally less contaminated or more homogeneous. To produce CCU plastics, carbon dioxide is separated from exhaust gas streams or from the air and then serves as a raw material or component for the production of energy sources such as methane or methanol or for the production of chemical raw materials such as polycarbonates or PVC. Both chemical and biological methods with algae or microorganisms are known for this purpose.

Mechanically recycled plastic may be recovered in the course of material recycling. Among other things, PCR plastics and PIR plastics may be mechanically recycled. Plastic waste is sorted according to the respective type of plastic and processed into recyclates, which can be used as a starting material for new products and thus replace plastics made from new materials. This type of recycling preserves the original chemical structure of the polymers.

According to a further embodiment, it is conceivable that the at least one recycled material and/or the at least one biologically degradable and/or marine-degradable material is at least one recycled metal material, in particular selected from the group consisting of silver, copper, aluminum, gold, platinum, niobium, tin, or nickel, titanium, vanadium, chromium, cobalt and palladium or alloys of these materials, in particular cobalt-nickel alloys, and/or at least one dielectric material, in particular selected from the group consisting of zinc sulphide (ZnS), zinc oxide (ZnO), zinc chromate (ZnCrO4), titanium dioxide (TiO2), carbon (C), indium oxide (In203), indium tin oxide (ITO), antimony tin oxide (ATO), fluorine tin oxide (FTO), tantalum pentoxide (Ta2O5), cerium oxide (CeO2), yttrium oxide (Y2O3), europium oxide (Eu2O3), iron oxides such as iron(II,III) oxide (Fe3O4) and iron(III) oxide (Fe2O3), hafnium nitride (HfN), hafnium carbide (HfC), hafnium oxide (HfO2), lanthanum oxide (La2O3), magnesium oxide (MgO), neodymium oxide (Nd2O3), praseodymium oxide (Pr6O11), samarium oxide (Sm2O3), antimony trioxide (Sb2O3), silicon carbide (SiC), silicon nitride (Si3N4), silicon monoxide (SiO), selenium trioxide (Se2O3), tin oxide (SnO2), tungsten trioxide (WO3), bismuth(III) oxide (Bi2O3), aluminum oxide (Al2O3), metal fluorides, for example magnesium fluoride (MgF2), aluminum fluoride (AlF3), cerium fluoride (CeF3), sodium aluminum fluorides (e.g. Na3AlF6 or Na5Al3F14), silicon oxide (SIOx), silicon dioxide (SiO2), neodymium fluoride (NdF3), lanthanum fluoride (LaF3), samarium fluoride (SmF3), barium fluoride (BaF2), calcium fluoride (CaF2), lithium fluoride (LiF), organic monomers and/or organic polymers or layers of metal oxides, such as non-stoichiometric aluminum oxide, copper oxides, or chromium oxides and/or is made from at least one recycled metal material from printing inks or varnishes or inks with at least one of these materials. The recycled metal material may be applied to or incorporated into printing inks, paints or inks, for example.

The use of sustainable raw materials for various coating materials (e.g. paint components, metals such as aluminum from recycled aluminum, etc.) has made it possible to produce sustainable decorative elements.

Furthermore, it may be advantageous if the cover layer 3 comprises a cover ply 9 configured as a film on the side facing the support layer 2 and if a decorative ply 10, in particular a printed image, is applied or arranged on the side of cover ply 9 facing away from the support layer 2. However, it may also be advantageous if the decorative ply, in particular the printed image, is incorporated in the cover ply. This makes it possible to create a high level of visual design options and/or adapt the decorative element to a wide variety of applications. The decorative ply or the printed image may, for example, be a printed varnish, a printed ink or a printed metal or metal alloy in liquid form.

A possible alternative configuration is that the cover layer is formed by a decorative ply, in particular by a printed image. This allows a relatively thin-walled film structure to be created, which may also be given a different visual appearance.

According to an expedient further embodiment, it is conceivable that a protective layer is formed on the side of the cover layer facing away from the support layer, in particular from a varnish, for example from a UV-cured clear varnish, or from an excimer varnish producing a matt appearance, which protective layer is preferably applied to the decorative ply, and which protective layer comprises the at least one recycled material and/or the at least one material made of renewable raw materials and/or the at least one biologically degradable and/or marine-degradable material. The side on which the protective varnish is applied is selected in such a way that the protective layer is on the outside of the applied decorative film. Preferably, the varnish has a high scratch resistance to protect the decorative element from mechanical damage. The UV-curing varnish may be, for example, a UV varnish based on acrylic monomers that can be polymerized by free radicals, or a varnish based on urethane monomers, or may comprise source materials for fluoropolymers. In particular, slot nozzles may be used to apply the varnish so that a homogeneous coating quality can be achieved, in particular for glossy applications.

Furthermore, it is also conceivable that the side of the support layer facing away from the cover layer is coated with a sealing layer, in particular made of a plastic, so that the support layer is arranged between the cover layer and the sealing layer. Alternatively, the cover layer may be coated with the sealing layer, or the cover layer itself may form the sealing layer. The sealing layer comprises the at least one recycled material and/or the at least one material made of renewable raw materials and/or the at least one biologically degradable and/or marine-degradable material. The function of the sealing layer is preferably to even out any unevenness in the surface of the object to which the decorative element can be applied. It is particularly preferable for the sealing layer to be a joint-filling material. An additional adhesive layer may be applied to the sealing layer to bond the decorative element to the surface of an object, such as a furniture front. Depending on the surface of the object, the sealing layer itself may stick to the surface or adhere permanently without the need for an additional adhesive. For example, an adhesive may be dispensed with for objects with a plastic surface, while the use of an additional adhesive may be advantageous for metal surfaces.

Furthermore, it may be provided that on the side of the support layer facing away from the cover layer an adhesive layer or a laminating layer can be arranged or is arranged on the side of the support layer facing away from the cover layer, which adhesive layer can be applied to a surface of a metallic and/or a polymeric object, and which adhesive layer preferably comprises at least one recycled material and/or at least one material made of renewable raw materials and/or at least one biologically degradable and/or marine-degradable material, wherein the support layer is a plastic film with at least 20% PCR material, preferably with at least 50% PCR content. However, it would also be conceivable and possibly expedient to use another recycled plastic material and/or a plastic material made of renewable materials and/or a biologically degradable and/or marine-degradable plastic material instead of the PCR material. This makes it possible to laminate and thus decorate both metal and plastic surfaces in a sustainable way by applying one or more decorative elements.

In another embodiment, a component composite comprises an object, in particular of plate-shaped design, with at least one surface or with at least one flat side of a supporting structure and at least one decorative element. The at least one decorative element configured according to the invention is arranged on the at least one surface and connected to the object.

A further embodiment provides that the object or supporting structure is selected from a material from the group of wood, wood composite material, plastic, glass, metal, ceramic, inorganic building materials such as concrete, eternit, or cellulose-containing materials, and that the material preferably comprises at least one recycled material, and/or at least one material made of renewable raw materials, and/or at least one biologically degradable and/or marine-degradable material. This makes it possible to use a wide variety of materials, depending on the respective application. This is particularly the case when the plate-shaped objects are furniture fronts made of veneer material. It is conceivable that the visible side of the veneer panel has a PET sheet or G-PET sheet consisting at least partially of recycled PET, and that the decorative element is applied to this PET and G-PET sheet.

Another embodiment is characterized by the fact that the at least one decorative element is formed onto the plate-shaped object or supporting structure, in particular extruded onto the supporting structure. This enables inline production. The directly produced decorative element may thus be applied directly to the object on the intended surface or the intended surface section without any intermediate step. In most cases, the decorative element or the layers forming the decorative element are produced in an extrusion process.

Another alternative embodiment is characterized in that an adhesive layer or a laminating layer is arranged on the side of the support layer facing away from the cover layer, and in that the adhesive layer preferably comprises at least one recycled material, and/or at least one material made of renewable raw materials, and/or at least one biologically degradable and/or marine-degradable material, wherein the support layer is a plastic film with at least 20% PCR material, preferably with at least 50% PCR content. However, it would also be conceivable and possibly expedient to use another recycled plastic material and/or a plastic material made of renewable materials and/or a biologically degradable and/or marine-degradable plastic material instead of the PCR material. The decorative element is connected to the object or carrier body by means of the adhesive layer. This enables the decorative element to be subsequently connected to the object. The adhesive forming the adhesive layer usually has a viscous or gel-like initial aggregate state. This only solidifies during the curing or setting process and forms the connection layer between the decorative element and the supporting structure.

### BRIEF DESCRIPTION OF THE DRAWINGS

For the purpose of better understanding of the invention, this will be elucidated in more detail by means of the figures below.

These show respectively in a very simplified schematic representation:

FIG. 1 a decorative element and an object in a spaced-apart arrangement before they are joined to form a component composite in sectional view,

FIG. 2 a component composite comprising a decorative element and an object in sectional view.

### DETAILED DESCRIPTION OF EXEMPLARY EMBODIMENTS

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

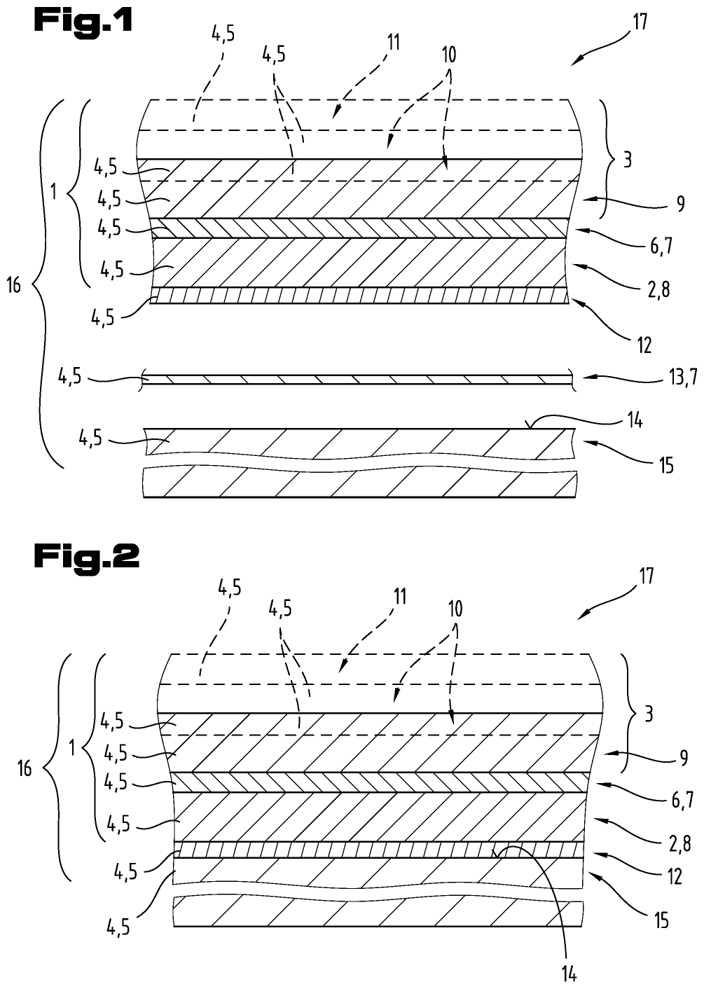

FIGS. 1 and 2 are described below largely in a synopsis to avoid unnecessary repetition. FIGS. 1 and 2 show an exemplary embodiment of a decorative element 1 and a detail of an object 15 wherein the film-like decorative element 1 is depicted in an arrangement spaced from the object 15 or before connecting it to the object 15 to form a component composite 16. FIG. 2 shows a component composite 16 or the decorative element 1 in its state connected to the object 15 or glued or applied to it.

The decorative element 1 comprises a support layer 2 and a cover layer 3 arranged on the support layer 2. The decorative element 1, in particular the support layer 2 or the cover layer 3, comprises at least one recycled material 4, and/or at least one material made of renewable raw materials, and/or at least one biologically degradable and/or marine-degradable material 5.

According to the example shown, a connection layer 6 or a laminating agent 7 may be provided on the side of the support layer 2 facing the visible side 17 of the decorative element 1. The cover layer 3 and the support layer 2 are connected together by means of the connection layer 6. Preferably, the connection layer 6 comprises at least one recycled material 4, and/or at least one material made of renewable raw materials, and/or at least one biologically degradable and/or marine-degradable material 5.

The decorative element 1 shown comprises at least 10%, preferably at least 20%, particularly preferably at least 30%, in particular at least 50% of the at least one recycled material 4 and/or the at least one material made of renewable raw materials and/or the at least one biologically degradable and/or marine-degradable material 5.

The at least one recycled material 4, and/or the at least one material made of renewable raw materials, and/or the at least one biologically degradable and/or marine-degradable material 5 may in particular be a cellulose fiber free material.

The support layer 2 is configured with at least one plastic film 8 or as a plastic film 8. The plastic film 8 comprises the at least one recycled material 4 and/or the at least one material made of renewable raw materials and/or the at least one biologically degradable and/or marine-degradable material 5.

For this purpose, the at least one recycled material 4 and/or the at least one biologically degradable and/or marine-degradable material 5 is a chemically recycled plastic and/or a mechanically recycled plastic, in particular a translucent recycled plastic. The at least one recycled material 4 and/or the at least one biologically degradable and/or marine-degradable material 5 preferably comprises at least one of the materials from the group consisting of polyimide (PI), polypropylene (PP), monoaxially oriented polypropylene (MOPP), biaxially oriented polypropylene (BOPP), polyethylene (PE), polyphenylene sulfide (PPS), polyetheretherketone (PEEK), polyetherketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), glycol-modified polyethylene terephthalate (G-PET), amorphous polyethylene terephthalate (A-PET), polyamide (PA), polycarbonate (PC), cycloolefin copolymers (COC), polyoxymethylene (POM), acrylonitrile butadiene styrene (ABS), polyvinyl chloride (PVC), ethylene tetrafluoroethylene (ETFE), polytetrafluoroethylene (PTFE), polyvinyl fluoride (PVF), polyvinylidene fluoride (PVDF) and ethylene-tetrafluoroethylene-hexafluoropropylene fluorterpolymer (EFEP), polymethyl methacrylate (PMMA), cellulose- or lignin-based plastics, polyhydroxyalkanoates (PHA), thermoplastic starch (TPS), polylactic acid (PLA), polycaprolactone (PCL), polybutylene butyl succinate (PBS), and polybutylene adipate terephthalate (PBAT) and/or mixtures and/or co-polymers and/or composite materials of these materials or is made from at least one of these materials.

In one embodiment, the at least one recycled material 4 and/or the at least one biologically degradable and/or marine-degradable material 5 comprise at least one recycled metal material, in particular selected from the group consisting of silver, copper, aluminum, gold, platinum, niobium, tin, or nickel, titanium, vanadium, chromium, cobalt and palladium or alloys of these materials, in particular cobalt-nickel alloys, and/or at least one dielectric material, in particular selected from the group consisting of zinc sulphide (ZnS), zinc oxide (ZnO), zinc chromate (ZnCrO4), titanium dioxide (TiO2), carbon (C), indium oxide (In2O3), indium tin oxide (ITO), antimony tin oxide (ATO), fluorine tin oxide (FTO), tantalum pentoxide (Ta2O5), cerium oxide (CeO2), yttrium oxide (Y2O3), europium oxide (Eu2O3), iron oxides such as iron(II,III) oxide (Fe3O4) and iron(III) oxide (Fe2O3), hafnium nitride (HfN), hafnium carbide (HfC), hafnium oxide (HfO2), lanthanum oxide (La2O3), magnesium oxide (MgO), neodymium oxide (Nd2O3), praseodymium oxide (Pr6O11), samarium oxide (Sm2O3), antimony trioxide (Sb2O3), silicon carbide (SiC), silicon nitride (Si3N4), silicon monoxide (SiO), selenium trioxide (Se2O3), tin oxide (SnO2), tungsten trioxide (WO3), bismuth(III) oxide (Bi2O3), aluminum oxide (Al2O3), metal fluorides, for example magnesium fluoride (MgF2), aluminum fluoride (AlF3), cerium fluoride (CeF3), sodium aluminum fluorides (e.g. Na3AlF6 or Na5Al3F14), silicon oxide (SIOx), silicon dioxide (SiO2), neodymium fluoride (NdF3), lanthanum fluoride (LaF3), samarium fluoride (SmF3), barium fluoride (BaF2), calcium fluoride (CaF2), lithium fluoride (LiF), organic monomers and/or organic polymers or layers of metal oxides, such as non-stoichiometric aluminum oxide, copper oxides, or chromium oxides and/or are made from at least one recycled metal material from printing inks or varnishes or inks containing at least one of these materials.

As shown in the figure, the cover layer 3 comprises a cover ply 9 in the form of a film on its side facing the support layer 2. In addition, a decorative ply 10, in particular a printed image, is applied or arranged on the side of this cover ply 9 facing away from the support layer 2. Alternatively, stroke-dotted lines indicate that it would also be conceivable for the decoratively 10, in particular the printed image, to be incorporated directly into the cover ply 9. It would also be conceivable for the cover layer 3 to be formed by a decorative ply 10, in particular by a printed image.

In addition, the exemplary embodiment shows that a protective layer 11 made of a varnish is formed on the side of the cover layer 3 facing away from the support layer 2, which protective layer 11 is preferably applied directly to the decorative ply 10. The protective layer 11 may also contain the at least one recycled material 4 and/or the at least one material made of renewable raw materials and/or the at least one biologically degradable and/or marine-degradable material 5.

The side of the support layer 2 facing away from the cover layer 3 is additionally coated with a sealing layer 12 made of a plastic, so that the support layer 2 is arranged between the cover layer 3 and the sealing layer 12. However, it is also conceivable that the cover layer 3 is coated with the sealing layer 12 or that the cover layer 3 itself forms the sealing layer 12. The sealing layer 12 preferably contains the at least one recycled material 4 and/or the at least one material made of renewable raw materials and/or the at least one biologically degradable and/or marine-degradable material 5.

FIGS. 1 and 2 also show that an adhesive layer 13 or a laminating agent 7 may be arranged or is arranged on the side of the support layer 2 facing away from the cover layer 3. This adhesive layer 13 may be attached to a surface 14 of a metallic and/or a polymeric object and preferably contains at least one recycled material 4, and/or at least one material made of renewable raw materials, and/or at least one biologically degradable and/or marine-degradable material 5. Preferably, the support layer 2 is a plastic film 8 with at least 20% PCR material, preferably with at least 50% PCR content. However, it would also be conceivable and possibly expedient to use another recycled plastic material and/or a plastic material made of renewable materials and/or a biologically degradable and/or marine-degradable plastic material instead of the PCR material.

In particular, FIG. 2 shows an exemplary embodiment of a component composite 16 which comprises an object 15, in particular in the form of a plate, with at least one surface 14 and at least one decorative element 1. The at least one decorative element 1 is arranged on the at least one surface 14 and connected to the object 15.

In addition, the object 15 is selected from a material from the group of wood, wood composite, plastic, glass, metal, ceramics, inorganic building materials such as concrete, eternit, or cellulose-containing materials, wherein the material preferably comprises at least one recycled material 4, and/or at least one material made of renewable raw materials, and/or at least one biologically degradable and/or marine-degradable material 5.

The at least one decorative element 1 may, for example, be formed onto the plate-shaped object 15, in particular extruded onto the object 15.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present disclosure lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be taken from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

1. Decorative element, comprising a support layer and a cover layer arranged on the support layer, wherein the decorative element comprises at least one recycled material, and/or at least one material made of renewable raw materials, and/or at least one biologically degradable and/or marine-degradable material.

2. Decorative element according to claim 1, wherein a connection layer is provided, by means of which connection layer the cover layer is connected to the support layer, which connection layer preferably comprises at least one recycled material, and/or at least one material made of renewable raw materials, and/or at least one biologically degradable and/or marine-degradable material.

3. Decorative element according to claim 1, wherein the decorative element comprises at least 10%, preferably at least 20%, particularly preferably at least 30%, in particular at least 50% of the at least one recycled material and/or of the at least one material made of renewable raw materials and/or of the at least one biologically degradable and/or marine-degradable material, or that the decorative element comprises at least 10%, preferably at least 20%, particularly preferably at least 30%, in particular at least 50% of several recycled materials and/or several materials made of renewable raw materials and/or several biologically degradable and/or marine-degradable materials.

4. Decorative element according to claim 1, wherein the at least one recycled material, and/or the at least one material made of renewable raw materials, and/or the at least one biologically degradable and/or marine-degradable material is a cellulose fiber free material.

5. Decorative element according to claim 1, wherein the decorative element, in particular the support layer, is configured with at least one plastic film or as a plastic film, which plastic film comprises the at least one recycled material and/or the at least one material made of renewable raw materials and/or the at least one biologically degradable and/or marine-degradable material.

6. Decorative element according to claim 1, wherein the at least one recycled material and/or the at least one biologically degradable and/or marine-degradable material comprises a chemically recycled plastic and/or a mechanically recycled plastic, in particular comprises a translucent recycled plastic, wherein the at least one recycled material and/or the at least one biologically degradable and/or marine-degradable material-(preferably comprises at least one of the materials from group consisting of polyimide (PI), polypropylene (PP), monoaxially oriented polypropylene (MOPP), biaxially oriented polypropylene (BOPP), polyethylene (PE), polyphenylene sulfide (PPS), polyetheretherketone (PEEK), polyetherketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), glycol-modified polyethylene terephthalate (G-PET), amorphous polyethylene terephthalate (A-PET), polyamide (PA), polycarbonate (PC), cycloolefin copolymers (COC), polyoxymethylene (POM), acrylonitrile butadiene styrene (ABS), polyvinyl chloride (PVC), ethylene tetrafluoroethylene (ETFE), polytetrafluoroethylene (PTFE), polyvinyl fluoride (PVF), polyvinylidene fluoride (PVDF) and ethylene tetrafluoroethylene hexafluoropropylene fluorterpolymer (EFEP), polymethyl methacrylate (PMMA), cellulose- or lignin-based plastics, polyhydroxyalkanoates (PHA), thermoplastic starch (TPS), polylactic acid (PLA), polycaprolactone (PCL), polybutylene succinate (PBS), and polybutylene adipate terephthalate (PBAT) and/or mixtures and/or co-polymers and/or composite materials of these materials or is made from at least one of these materials.

7. Decorative element according to claim 1, wherein the at least one recycled material and/or the at least one biologically degradable and/or marine-degradable material is at least one recycled metal material, in particular selected from the group consisting of silver, copper, aluminum, gold, platinum, niobium, tin, or nickel, titanium, vanadium, chromium, cobalt and palladium or alloys of these materials, in particular cobalt-nickel alloys, and/or at least one dielectric material, in particular selected from the group consisting of zinc sulphide (ZnS), zinc oxide (ZnO), zinc chromate (ZnCrO₄), titanium dioxide (TiO₂), carbon (C), indium oxide (In₂O₃), indium tin oxide (ITO), antimony tin oxide (ATO), fluorine tin oxide (FTO), tantalum pentoxide (Ta₂O₅), cerium oxide (CeO₂), yttrium oxide (Y₂O₃), europium oxide (Eu₂O₃), Iron oxides such as iron(II, III) oxide (Fe₃O₄) and iron(III) oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon carbide (SiC), silicon nitride (Si₃N₄), silicon monoxide (SiO), selenium trioxide (Se₂O₃), tin oxide (SnO₂), tungsten trioxide (WO₃), bismuth(III) oxide (Bi₂O₃), aluminum oxide (Al₂O₃), metal fluorides, for example magnesium fluoride (MgF₂), aluminum fluoride (AlF₃), cerium fluoride (CeF₃), sodium aluminum fluorides (e.g. Na₃AlF₆ or Na₅Al₃F₁₄), silicon oxide (SIOₓ), silicon dioxide (SiO₂), neodymium fluoride (NdF₃), lanthanum fluoride (LaF₃), samarium fluoride (SmF₃), barium fluoride (BaF₂), calcium fluoride (CaF₂), lithium fluoride (LiF), organic monomers and/or organic polymers or layers of metal oxides, such as non-stoichiometric aluminum oxide, copper oxides, or chromium oxides, and/or is made from at least one recycled metal material from printing inks or varnishes or inks, in particular with at least one of these materials.

8. Decorative element according to claim 1, wherein the cover layer comprises a cover ply in the form of a film on its side facing the support layer, and in that a decorative ply, in particular a printed image, is applied or arranged on the side of the cover ply facing away from the support layer, or in that the decorative ply, in particular the printed image, is accommodated in the cover ply.

9. Decorative element according to claim 1, wherein the cover layer is formed by a decorative ply, in particular by a printed image.

10. Decorative element according to claim 1, wherein a protective layer, in particular of a varnish, is formed on the side of the cover layer facing away from the support layer, which protective layer is preferably applied to the decorative layer, and which protective layer comprises the at least one recycled material and/or the at least one material made of renewable raw materials and/or the at least one biologically degradable and/or marine-degradable material.

11. Decorative element according to claim 1, wherein the side of the support layer facing away from the cover layer is coated with a sealing layer, in particular of a plastic, so that the support layer is arranged between the cover layer and the sealing layer, or that the cover layer is coated with the sealing layer, or that the cover layer itself forms the sealing layer, wherein the sealing layer comprises the at least one recycled material and/or the at least one material made of renewable raw materials and/or the at least one biologically degradable and/or marine-degradable material.

12. Decorative element according to claim 1, wherein an adhesive layer may be arranged or is arranged on the side of the support layer facing away from the cover layer, which adhesive layer may be attached to a surface of a metallic and/or a polymeric object, and which adhesive layer preferably comprises at least one recycled material, and/or at least one material made of renewable raw materials, and/or at least one biologically degradable and/or marine-degradable material, wherein the support layer is a plastic film with at least 20% recycled and/or made from renewable raw materials and/or biologically degradable and/or marine-degradable plastic material, in particular a PCR material, preferably with at least 50% PCR content.

13. Component composite comprising an object, in particular in the form of a plate, with at least one surface and at least one decorative element, wherein the at least one decorative element is arranged on the at least one surface and is connected to the object, and wherein the decorative element is configured according to claim 1.

14. Component composite according to claim 13, wherein the object is selected from a material from the group of wood, wood composite material, plastic, glass, metal, ceramic, inorganic building materials such as concrete, eternit, or cellulose-containing materials, and that the material preferably comprises at least one recycled material, and/or at least one material made of renewable raw materials, and/or at least one biologically degradable and/or marine-degradable material.

15. Component composite according to claim 13, wherein the at least one decorative element is formed onto the plate-shaped object, in particular extruded onto the object.

16. Component composite according to claim 13, wherein an adhesive layer is arranged on the side of the support layer facing away from the cover layer, and which adhesive layer preferably comprises at least one recycled material, and/or at least one material made of renewable raw materials, and/or at least one biologically degradable and/or marine-degradable material, wherein the support layer is a plastic film with at least 20% of recycled and/or renewable and/or biologically degradable and/or marine-degradable plastic material, in particular a PCR material, preferably with at least 50% PCR content.
